(19) United States
(12) Patent Application Publication
(10) Pub. No.: US 2003/0226376 A1
(43) Pub. Date: Dec. 11, 2003

(54) Fabrication of heavy walled silica tubing

(75) Inventors: Michael P. Winnen, Lakewood, OH (US); Frederic F. Ahlgren, Highland Heights, OH (US); Fred D'Orazio, Kirtland, OH (US); Michael D. Walker, Richmond Heights, OH (US)

Correspondence Address: Hanh T. Pham, General Electric Company, One Plastics Avenue, Pittsfield, MA, 01201, US

(73) Assignee: GENERAL ELECTRIC COMPANY

(21) Appl. No.: 10/166,442

(22) Filed: Jun. 10, 2002

(51) Int. Cl. C03B 19/06

(52) U.S. Cl. 65/17.4; 65/17.6; 65/436; 65/32.1

(57) ABSTRACT

A method for producing a silica glass body having a low bubble content includes melting silica sand in a chamber (62) of a rotating furnace housing (20) to form molten silica. Helium-containing gas is fed into the chamber, both during introduction of the sand and during the heating step. The helium diffuses more readily from the molten silica than other gases, resulting in lower bubble content. The furnace is heated by establishing a gas plasma arc (60) between spaced electrodes (64, 66) within the chamber.

### BACKGROUND OF THE INVENTION

The present invention relates generally to the manufacture of silica (SiO₂) glass and more particularly to the fabrication of heavy-walled SiO₂ with a low content of bubbles.

SiO₂ glass, sometimes described as “fused quartz” is widely used for a variety of applications. In tubular form, it is used for semiconductor wafer processing. For example, the tubes are formed into high purity containers for use in the manufacture of semiconductor materials, i.e., for holding semiconductor materials in processing steps, such as melting, zone-refining, diffusion, or epitaxy. For this and other uses, transparent SiO₂ glass which is bubble-free and as homogeneous as possible is preferred. Other uses for the transparent SiO₂ glass include optical components, such as envelopes for high-temperature, high intensity and thus high efficiency lamps and energy transmitting fibers for optical telecommunications systems.

For the manufacture of such tubing, both natural and man-made silica materials are utilized. Natural silicas include granular materials derived through physical and chemical benefication from idiomorphic quartz, such as quartz crystals or xenomorphic vein or pegmatite quartzes. Sedimentary quartz is generally not used when a high transparency is desired. Among the man-made silicas are those derived as high purity precipitations and depositions from SiO₂-containing solutions or vapors.

The manufacture of SiO₂ glass tubing typically includes charging a horizontally aligned cylindrical furnace chamber with granular quartz (SiO₂ sand) and heating the furnace to melt the sand, often with rotation of the chamber. Heating of the furnace may be carried out with internal resistance heating elements or with an elongated high powered plasma arc. In both these processes, the melting proceeds radially from the side of the granular charge closest to the heat source. With the flow of heat, a temperature gradient develops across the thickness of the melt and the melting is thereby non-isothermic. The temperature on the heated surface of the melt, because of the limitations inherent in the heating element, does not generally exceed 2000° C., while the furthest layer of the melt does not generally exceed the melting point of cristobalite, i.e., 1723° C.

U.S. Pat. No. 3,853,520, for example, discloses heating silica starting material in a rotating hollow form under vacuum using resistive or induction heating elements. An inert gas, such as nitrogen, is admitted during the cooling phase to cool the hollow form more rapidly without oxidation of the graphite parts. U.S. Pat. No. 4,212,661 suggests circulating a dry inert gas, such as nitrogen or argon, while a fused quartz ingot is being formed.

For heavy walled (25 mm or greater) fused silica tubing used in the semiconductor wafer processing industry, the purity of the tubing is extremely important. The silica used as the raw material is preferably free of entrained air and contamination, i.e., have a high bulk purity. Surfaces of the grains are also preferably free of contamination. The fusion equipment used to form the SiO₂ glass should also minimize surface pick-up of contamination.

Due to its relatively small particle size, silica sand is easily loaded into the rotating furnace chamber using a pneumatic conveying system. This technique of “spraying” the sand onto the inner diameter of the rotating cylinder can be well controlled to provide a uniform sand layer thickness. However, the resultant bubble quality of the fused glass tends to suffer as small voids between the melting sand particles typically form very small bubbles (of about 20-50 micrometers in diameter), especially when the surface of the sand grains is contaminated.

Various proposed methods of reducing the formation of deleterious bubbles have been suggested (see, e.g., U.S. Pat. No. 5,312,471). It has been proposed that, through rapid rotation of the melt, gas bubbles would be floated to and escape from the inner surface of the melt. However, concentrated bubble layers are still observed in the outer surface of the melt, even at high rotation speed. Other proposals use high gaseous pressure within the melting furnace in an attempt to reduce or to eliminate SiO₂ vaporization and to facilitate further superheating of the melt. While the higher temperatures favor increases in the mobility of the bubbles, the higher pressure, intended to reduce or eliminate vaporization, is counterproductive in that it also tends to compress and to reduce the size of the bubbles and thus decrease their mobility which is proportional to the square of their radii.

In another method, two heat sources, such as resistance heating and flame heating, are used in combination to heat the sand from both sides of the charge. However, the flame used as the second heat source releases hydroxyl groups and other species which may lead to impurities in the glass. In another method, described in U.S. Pat. No. 5,312,471, the rate of introduction of the granular quartz feed is controlled so that the rate of decrease of the inner radius of the melt is no greater than the escape rate of the smallest bubbles present in the melt desired to be removed to achieve a specified optical quality. The method can achieve good results, but it increases processing time, particularly when high optical quality (i.e., small bubble size) is desired.

The present invention provides a new and improved method of forming SiO₂ glass, which overcomes the above-referenced problems, and others.

### SUMMARY OF THE INVENTION

In an exemplary embodiment of the present invention, a method for producing a silica glass body having a low bubble concentration is provided. The method includes feeding silica particles into a chamber of a rotating furnace and heating the silica particles in the furnace chamber to form molten silica in a first process gas which includes helium. The molten silica is cooled to form the tubular silica glass body.

In another exemplary embodiment of the present invention, a method for producing a silica glass body having a low bubble concentration is provided. The method includes melting silica in chamber of a furnace by establishing a gas plasma arc between spaced electrodes within the chamber. During the step of melting, a process gas is fed into the chamber, the process gas including at least about 70% by weight of helium.

In another exemplary embodiment of the present invention, an apparatus for producing a silica glass body having a low bubble concentration is provided. The apparatus includes a housing which defines an interior chamber and means for feeding silica particles into the chamber. First and second spaced electrodes extend into the chamber. A source of power is connected with the electrodes for generating an arc between the electrodes for heating the chamber. A source of a first process gas which includes helium and a source of a second process gas which includes argon are provided. A manifold selectively fluidly connects the first and second sources of process gas with the chamber.

One advantage of at least one embodiment of the present invention is that it enables formation of a transparent SiO₂ glass.

Another advantage of at least one embodiment of the present invention is in reduced bubble content of the glass.

Still further advantages of the present invention will become apparent to those of ordinary skill in the art upon reading and understanding the following detailed description of the preferred embodiments.

### BRIEF DESCRIPTION OF THE DRAWINGS

FIG. 1 is a perspective view of a furnace in an embodiment of the present invention;

FIG. 2 is a cross-sectional view of the furnace of FIG. 1;

FIG. 3 is a cross-sectional view of a furnace in another embodiment of the present invention;

FIG. 4 is a schematic view of a pneumatic feed system in combination with the furnace of FIG. 1;

FIG. 5 is a schematic view of process gas feed system in combination with the furnace of FIG. 1;

FIG. 6 is a plot of bubble density (number of bubbles/cm³) vs. wall location for furnace cycles with various gases and mixtures; and

FIG. 7 is a plot of bubble diameter vs. wall location for furnace cycles with various gases and mixtures.

### DETAILED DESCRIPTION OF THE INVENTION

Improvements in quality of silica glass resulting from a reduction in bubble formation are achieved by increasing the rate at which bubbles escape from the molten glass during formation of the glass. By selecting suitable gases or mixtures of gases for feeding the silica sand into a processing furnace and/or as a process gas for the fusion process, significant reductions in bubble formation are obtained.

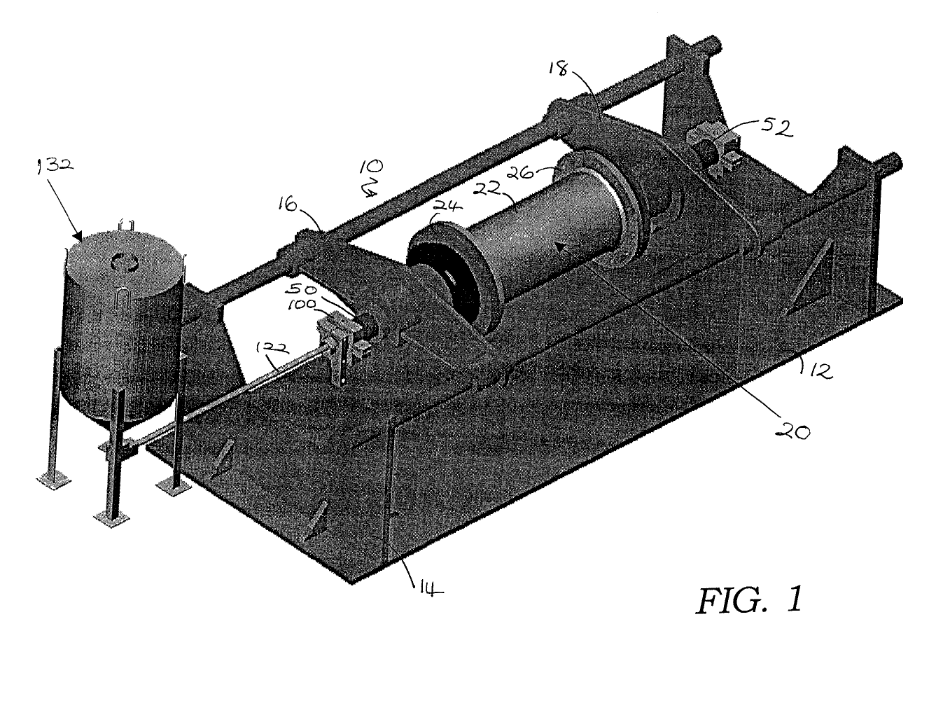

FIG. 1 shows an exemplary rotary furnace 10 for performing the fusion process, although it will be appreciated that the specific construction of the furnace may be varied. While the furnace is shown as using plasma arc heating, it is to be appreciated that a resistance heating or other heating system for the furnace may alternatively be used.

As used herein, the term “particles” is used to refer to all small, comminuted, granular, precipitations, depositions, slugs, or other finely divided silica used as a raw material in forming the silica glass. The terms “SiO₂” and silica are used interchangeably and refer to both natural and man-made silica materials and to combinations thereof.

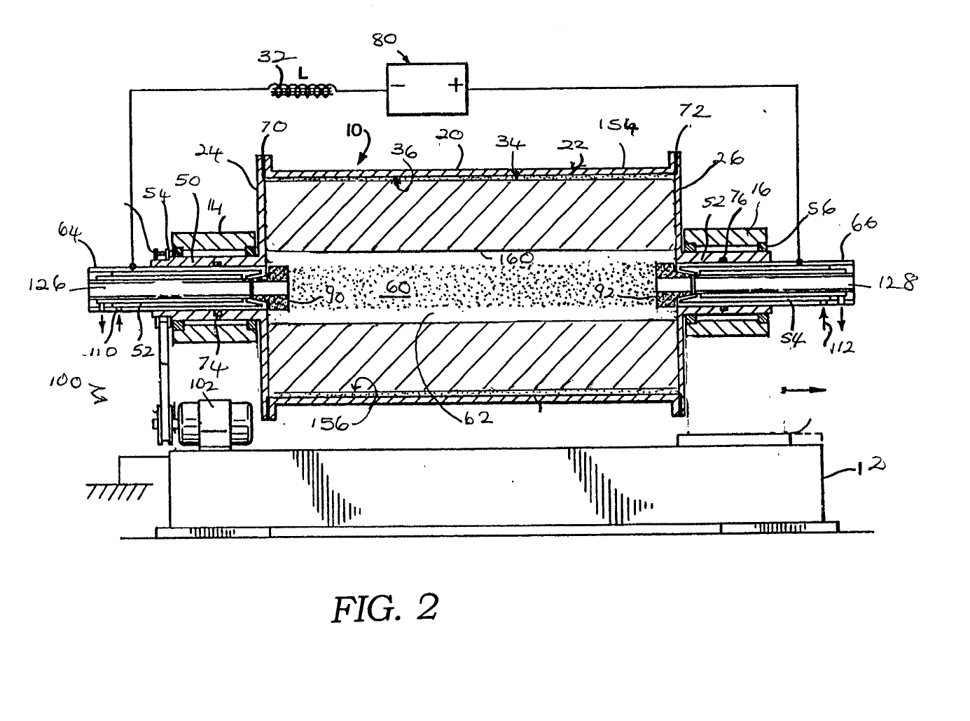

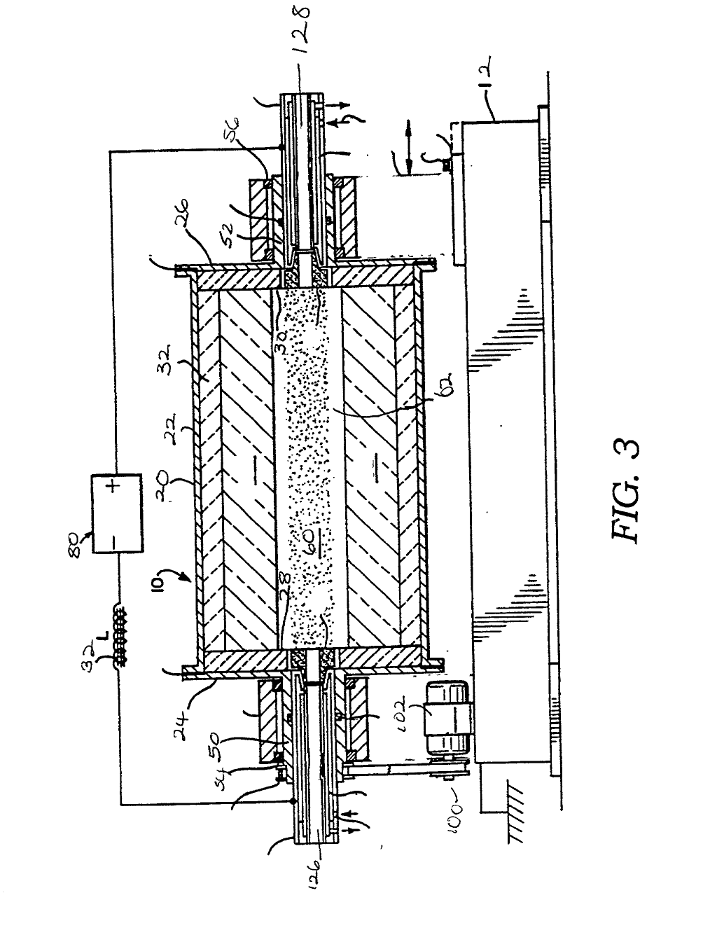

With reference also to FIG. 2, the furnace 10 includes a machine bed 12 with floor mounting pads 14, and left and right supports 16,18. A housing 20 of the rotary furnace 10 is in the shape of a drum and is made up of three components, a hollow cylindrical section 22, a left-hand flanged cover 24 and a right-hand flanged cover 26. Optionally, both flanged covers 24 and 26 are thermally insulated toward the furnace interior, facing the plasma arc, with doughnut-shaped monolithic refractories 28, 30 (FIG. 3). Additional insulation 32 may also cover the interior of the cylindrical section 22 and may be granular or solid (monolithic) in nature, such as a layer of zirconia or alumina, optionally covered by a molybdenum foil.

However, for high purity glass it is preferred that the insulation 28, 30, 32 be omitted, as shown in FIG. 2. In one embodiment, a layer 34 of silica sand, which remains unmolten throughout the process, acts as an insulation layer between the molten silica and an inner surface 36 of the housing 20. In this embodiment, the housing walls are preferably formed from a low carbon steel, such as 1018 grade steel, which may be polished on its inner surface 36. Before use, the inner surface 36 is wiped with a solvent, such as methanol, to remove contaminants.

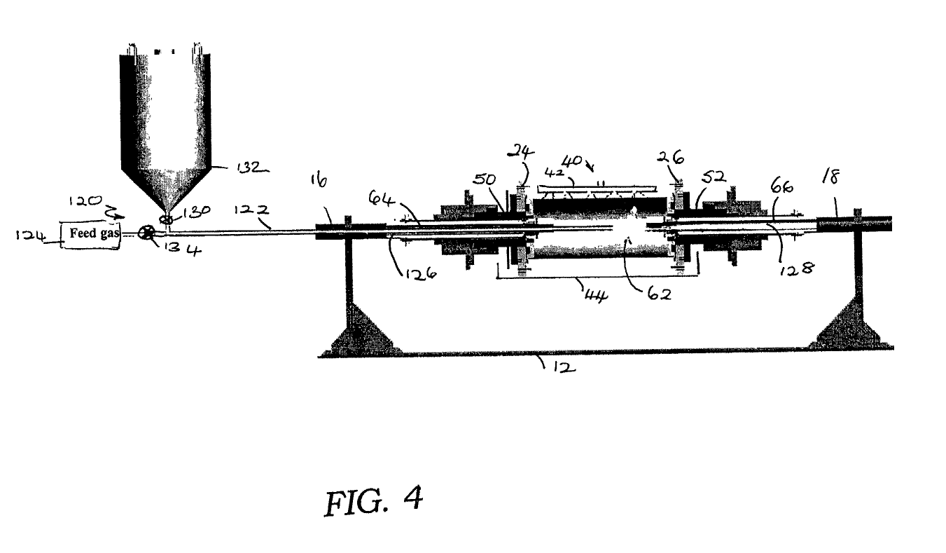

A cooling system 40 for the furnace housing 20 consists of a “shower head” type water ejector 42 located parallel to the horizontal furnace axis, directly above the furnace housing 20 (FIG. 4). The water ejector 42 has a multitude of orifices which direct spray jets at the furnace housing 20. The run-off water is collected in a pan 44 directly below the housing 20 where it can be collected, recycled and passed through a cooling system of its own (not shown). Optionally, the furnace housing itself is partially submerged in the pan 44 in order to receive additional cooling of its flanges 24 and 26, although it is generally more effective to cool the furnace with the spray jets. One purpose of this cooling system is to enable minimization, more preferably, total elimination, of the thickness of the protective insulating layer 28, 30, 32 within the furnace housing.

Returning to FIG. 2, axial extensions 50, 52 of flanges 24, 26 serve to rotatably support the furnace 10 through bearing assemblies 54 and 56. An arc 60 is generated within an elongated cylindrical chamber 62 defined within the housing 20. Both flanged covers 24 and 26 are respectively penetrated by non-rotating, hollow water-cooled electrodes 64, 66, formed, for example, from copper. The electrodes 64, 66 are also suitably electrically isolated from (insulated from) the rotating flanges to allow the connection of a high current/high voltage DC power supply.

The furnace 10 is hermetically sealed to allow the furnace to operate under vacuum or at elevated pressures and different gases or mixtures of gases. For this purpose, gasket-type seals 70, 72 are provided to seal the flanged covers 24, 26 to the cylindrical section 22 and O-rings 74, 76 are provided to seal the electrodes 64, 66 within the axial extensions 50, 52. When the furnace is heated with an arc 60, it is preferable for the helium pressure to be within the range of about 0.1 to 3 atmospheres, more preferably, at least 0.5 atmospheres, in order to sustain the arc. However, if another heating source, such as a resistance heater, is used in place of the arc, pressures outside this range are also contemplated.

The rotating furnace assembly 10 is grounded. Any DC power supply 80 can be employed as long as requirements for total power and regulation thereof are met. An additional inductor 82 may be added in series with power supply 80 in order to aid in maintaining the stability of the arc 60 by preventing the power from dropping to zero during the melting operation. Hollow, consumable stubs 90, 92 extend from the electrodes, which may be formed from carbon, e.g., graphite, tungsten, or other electrically conductive, high temperature refractory material.

A drive system 100 for rotating the housing 20 includes a variable speed motor 102, which is used to rotate (directly or indirectly) the hollow shaft or axial extension 50 which forms part of the left-hand furnace flange 24.

A coolant is introduced through inlets 110, 112 for circulation through annular passages 114, 116 of the hollow electrodes 64, 66 to control the temperature of electrodes.

The silica sand is introduced to the furnace by a pneumatic feed system 120 (FIG. 4). The pneumatic feed system 120 uses a feed gas to transport the silica sand particles to the furnace through a feed tube 122. The feed gas is supplied from a source 124 of feed gas, such as a pressurized cylinder, and mixes with the silica sand passing through the feed tube 122. The feed tube is fluidly connected with a bore 126 defined through one of the electrodes 64 (the inlet electrode). The mixture of sand and feed gas is preferably fed through the bore 126 into the empty, rotating housing 20 while the housing is still cold (i.e., prior to initiating the arc 60). The atmosphere within the furnace chamber 62 is initially one of ambient air, although it is also contemplated that an initial purge of feed gas may be supplied to the chamber prior to introduction of the silica sand. Excess pressure is released from the chamber 62 via a bore 128 in the other electrode 66, which will be referred to as the exhaust electrode.

Specifically, as shown in FIG. 4, a charge feeder in the form of a manifold valve 130 supplies the furnace 10 with particulate silica raw material received from a hopper 132. A manifold valve 134 controls the rate of introduction of feed gas from the compressed gas source 124. On passing through the manifold valve 134, the gas picks up the feed material. The gas carries the sand to the chamber 62, where it is directed against the rotating cylinder wall 22. Of course, other feed devices may be substituted for manifold valve 130. For example, a continuous feed system such as a venturi may be used.

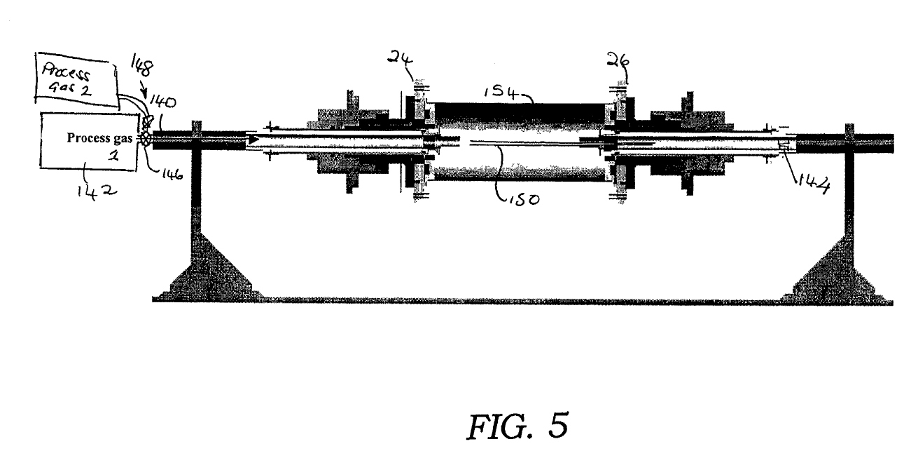

Once the charge of sand has been introduced to the chamber, the pneumatic feed system is uncoupled from the furnace 10. A process gas supply tube 140 is then coupled with the bore 126 (FIG. 5) and a flow of process gas is fed to the chamber 62 from a source of process gas, such as a pressurized cylinder 142. A restrictor 144 fitted to the exhaust bore 128 maintains a slight overpressure in the chamber 62 to prevent ingress of air during the fusion process. Flow into the chamber 62 is controlled by a regulator 146 and is preferably maintained at about 200 cubic ft/hr.

Once the charge of silica sand has been introduced to the chamber 62, the plasma arc 60 is established between the consumable electrode extensions 90,92. This can be accomplished in a variety of ways. For example, a striker electrode 150, such as a graphite rod, is fitted into the exhaust electrode bore 128 (FIG. 5). The striker electrode 150 is advanced until it contacts the stub 90 (FIG. 2) of the electrode 64 and power is supplied to generate an arc. The striker electrode 150 is gradually withdrawn into the exhaust electrode 66 and the arc is formed between the two electrodes 64, 66. Alternatively, motive means are used to bring one or both of the electrodes 64, 66 to a position adjacent the other for initiation of the arc and then the electrodes are moved apart to their operating positions.

The arc heats the silica sand, gradually converting it to a molten (fused) state. The layer of sand closest to the arc melts first, with the melt front gradually extending outward, toward the housing wall surface 36 until all of the sand that is to be melted has melted (FIG. 2). At this time, termed herein as the “melting time,” a thin layer 34 of umnolten silica sand remains between the molten silica and the housing wall surface 36, which remains in the unmolten state throughout the rest of the processing. The period of time approximately up to the melting time will be referred to as the “initial stage” or melting stage of the process and the period following the initial stage, i.e., the period approximately following the melting time will be referred to as the “second stage” or post melting stage. An outer surface 154 of the cylindrical housing is actively cooled, which, in the post melting stage, prevents further progression of the melt front 156. The thin layer 34 of silica sand remaining aids in removal of the finished tube from the chamber 62. The time taken for completing the first stage depends on the power supplied and other factors, such as the amount of feed material. Typically, 20-30 minutes is sufficient to complete the first stage at a power input of about 400 KW.

The feed gas which is mixed with the silica sand for pneumatically introducing the sand into the chamber 62 preferably includes helium. The feed gas may be pure helium or a mixture of helium and another gas or gases, such as oxygen. (By “pure helium,” it is meant 99.9% He, or greater.) For example, the feed gas may contain from 0 to about 20% oxygen by weight and 100 to about 80% helium by weight. It is also contemplated that a small amount of argon or other inert gas may also be present in the feed gas, preferably less than 20% argon by weight, more preferably less than 10% argon by weight, most preferably, the feed gas is free of argon. In a preferred embodiment, the feed gas is at least 70% by weight helium, more preferably, 95% helium, and most preferably about 100% helium.

The process gas which is fed into the chamber 62 during the initial stage of the melting process, and optionally also in the second stage, is preferably also helium or a mixture of helium with other gas or gases. The process gas can be the same gas or mixture of gases as the feed gas. For example, the process gas may be pure helium or a mixture of helium with oxygen as for the feed gas, e.g., from 0 to about 20% oxygen by weight and 100 to about 80% helium by weight. More preferably, the process gas, during at least the initial stage of the melting process, is free of oxygen, and is preferably 100% by weight or close to 100% by weight helium (i.e., at least 70% by weight helium, more preferably, at least 80% helium by weight, and most preferably over 95% helium by weight). It is also contemplated that a small amount of argon may also be present in the process gas during the initial stage of the melting process, preferably less than 10% argon.

Oxygen has been found to be helpful as a refining agent when contaminants are present on the silica. Coupled with the heat of the fusion process, oxygen provides an atmosphere that will burn off hydrocarbons and other volatile contaminants on the sand. The contaminants are thus removed from the sand bed, and the atmosphere of the chamber 62, prior to melting of the glass, i.e., before they can become trapped in the glass as bubbles. However, oxygen has been found to be deleterious in terms of the formation of bubbles. Accordingly, when high purity sand (i.e., sand with little or no volatilizable organic components) is used, the concentration of oxygen in the feed and/or process gas can be lower, or eliminated altogether. Thus, an improvement in glass quality is obtaining by ensuring that the silica sand is of high purity and then reducing or totally eliminating the oxygen from the feed gas and process gas. When poorer purity sand is used, the presence of oxygen may be beneficial overall because of its refining properties. By experimentation, the minimum level of oxygen can be determined which will provide for the removal of volatile organics while achieving the lowest bubble formation. This level is generally between about 1% by weight and about 20% by weight oxygen.

In one embodiment, the feed gas contains oxygen in addition to helium while the process gas is free or substantially free of oxygen. Or, the concentration of oxygen in the process gas is gradually reduced during the initial stage of processing.

Helium has been found particularly effective at reducing the formation of bubbles in the final fused silica product. The bubble count (number of bubbles per unit volume) is decreased when compared with other process gases. It has been found that helium has a high rate of diffusion in molten silica, diffusing more rapidly through the molten silica than other gases, such as nitrogen and argon, at least in the initial stage of processing. Additionally, in the temperature range of 1700° C. to 2000° C., the approximate melt temperature range, the temperature has relatively little effect on its diffusion coefficient.

In general, during any silica melting process, large bubbles (about 200 micrometers and larger) tend to rise to an inner surface 160 of the melt to escape the glass (FIG. 2). However, smaller bubbles (less than about 100 micrometers) do not rise so quickly and have a tendency to be trapped in the glass. Helium has been found to produce a decrease in both the large and small bubbles. Using helium in the feed gas and/or the process gas results in a decrease in both large and small bubbles. Although not fully understood, it is suggested that the decrease in small bubbles may result from bubble ripening, or growth in size through diffusion. Helium diffuses readily in the molten glass such that small bubbles become smaller as the gas diffuses from them to the larger bubbles. As these bubbles become larger, they are able to rise more rapidly through the melt and are more likely to escape the glass during the fusion cycle.

Optionally, at least some or all of the helium in the process gas is replaced with argon during processing. It has been found desirable to include helium in the process gas for at least a part, preferably all of the initial stage. However, improved results have been found in bubble quality when argon is used later in the process, preferably in the second stage.

For example, helium, or a mixture of primarily helium together with another gas or gases is used in the initial stage. Then, pure argon, or a mixture of primarily argon together with other gases is used in the second stage. (By “pure argon,” it is meant 99.9% Ar, or greater.) For example, valve 146 forms part of a manifold 148, which selectively supplies the process gas from first and second cylinders of helium-containing gas and argon, respectively. Pure argon is preferred for the second stage, although a mixture of argon with another gas, such as helium, preferably less than 50% helium by weight, more preferably, less than 20% helium by weight, and most preferably, less than 10% helium by weight can be used in the second stage. As with the first stage, the pressure is preferably sufficient to sustain the arc, i.e., a chamber pressure of about 0.1 to 3 atm., more preferably, at least 0.5 atm.

While not fully understood, it is suggested that an argon-based processing gas used in the second stage (i.e., when melting has occurred) has beneficial effects. Once the glass melt front has stabilized with the cooling of the outer surface of the cylindrical housing, the molten glass is purified of any remaining bubbles. Changing the process gas mixture from helium or helium-oxygen to argon reduces the number of these remaining bubbles. Samples of glass produced by this two-stage process had bands of lower bubble count near an inner surface 160 of the glass tube (FIG. 2). It is suggested that the effect of changing to argon is to reduce the partial pressure of helium and oxygen (where present) in the atmosphere within the chamber 62. This reduction provides an additional driving force for helium to diffuse to the inner melt surface 160 and out of the glass. Additionally, argon has less of a tendency to diffuse into the molten glass than other gases.

Preferably, the process gas and also the feed gas are free, or substantially free (i.e., less than 5% by weight, more preferably, less than 1% by weight), of nitrogen.

Surprisingly, it has been found that the advantages of argon in the second stage are not generally found in the first stage. A comparison of glass formed by the two-stage process (helium in stage one, argon in stage two) with glass formed in an argon atmosphere throughout the process showed improved homogeneity in bubble distribution in the two-stage process. The argon-processed samples had a mixture of regions, some with a high bubble count, others with a low bubble count. While glass produced with a helium atmosphere throughout showed improvements over glass produced with an argon atmosphere throughout, the two stage process showed the best results overall.

Optionally, corrosive and reactive gases may be added to the feed gas or plasma arc atmosphere in small quantities, to purify the particulate feed material before it actually becomes part of the melt. Preferably, less than one percent of chlorine or similar corrosive gases are present in the feed gas.

After the heating stage is complete, the molten glass is cooled or allowed to cool in the chamber 62 to a temperature at which the glass becomes solid. The solid tubular silica glass body thus formed is then removed from the chamber.

The method is particularly suited for forming tubes suited to processing applications in the semiconductor industry. For example, tubes having a wall thickness of from about 1 cm to about 10 cm and an outer diameter (O.D.) of from about 15 cm to about 50 cm are readily formed by the process described, although other dimensions are also contemplated. The tubes may be sectioned into rings and mounted on a suitable substrate for semiconductor processing applications.

Without intending to limit the scope of the invention, the following examples demonstrate the reduction in bubble formation using the present process.

### EXAMPLES

Several different types of gas were used for feeding and fusion to investigate the effect of gas type on fusion quality and bubble content. Gas types used for this test were as follows

1. Pure Ar (99.998% Ar, O₂<5 ppm, H₂O<3 ppm)

2. Pure He (99.995% He, O₂<5 ppm, H₂O<5 ppm)

3. He (80% by weight)/O₂ (20% by weight)

4. Pure N₂

These gases were used for both feeding the sand and also as an arc discharge medium (process gas) during fusion. All gas types were tested under similar run conditions. These parameters include:

| | |
|---|---|
| Sand Type | QQII |
| Load Weight (lb) | 100 |
| Feed Gas Flow (SCFH) | 200 |
| Load Tube Material | 6061 Al |
| Pump/flush cycles | None |
| Vacuum | None |
| Power Schedule | 15 min @350 kW, 5 min @200 kW |
| Fusion Time | 20 min |
| Process Gas Flow (SCFH) | 250 at High Power, 150 @ Low Power |

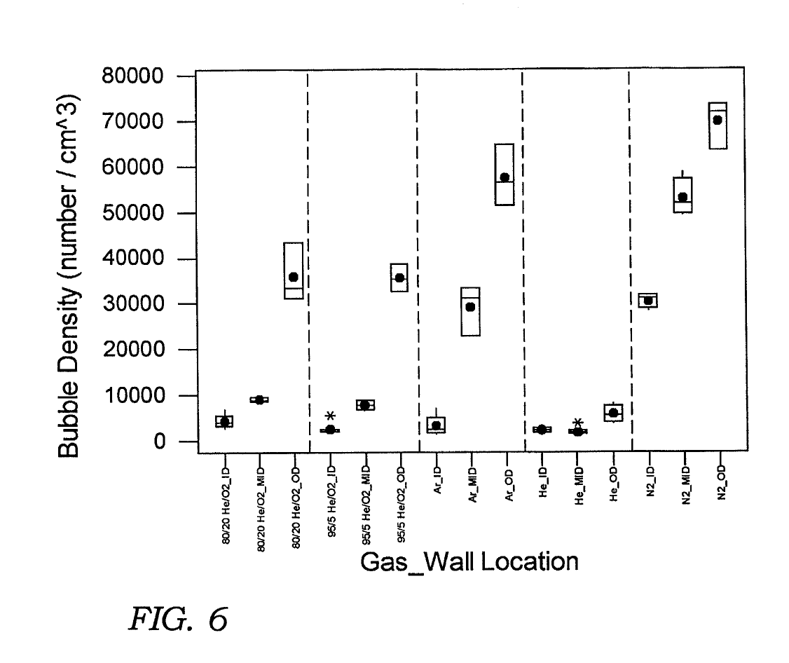

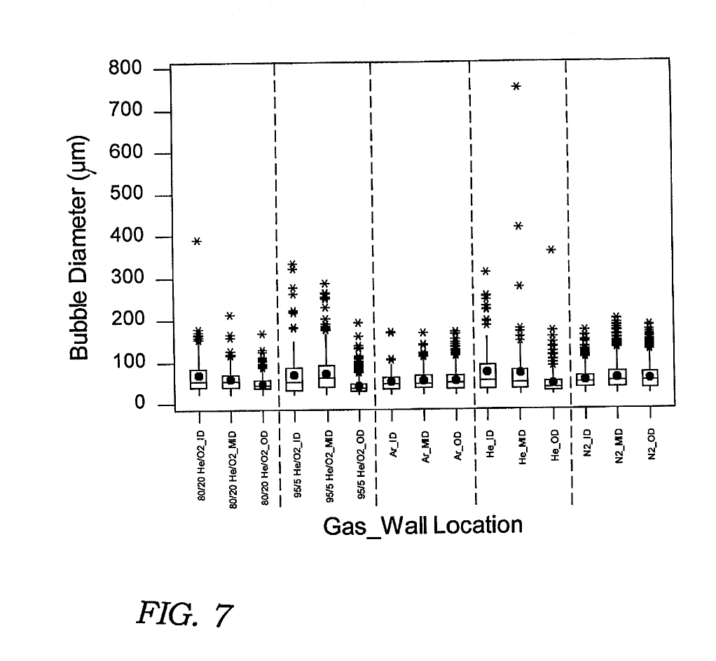

Bubble data obtained are shown in FIG. 6 (Bubble Density, Number/cm³) and FIG. 7 (Bubble Size, Diameter in micrometers), grouped by gas type, then by wall location (for example: 80/20 HeO2_ID represents the quartz sample from the 80% He 20% O₂ gas run with measurements taken near the inner diameter of the tube). Bubble Density represents the total number of bubbles per unit volume. Bubble diameter is an estimate of the bubble size using the bubble area, assuming a spherical shape.

Based on bubble density and size data, He gives a uniform gas content throughout the wall thickness while all other gases yield gradients in gas content, increasing from ID to OD (outer diameter). He/O₂ mixes, He, and Ar yield similar area fractions and densities for ID samples.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method for producing a tubular silica glass body having a low bubble concentration comprising the steps of:
feeding silica particles into a chamber of a rotating furnace;
heating the silica particles in the furnace chamber to form molten silica in a first process gas which includes helium; and
cooling the molten silica to form the tubular silica glass body.

2. The method of claim 1, wherein the first process gas includes at least 80% helium by weight.

3. The method of claim 2, wherein the first process gas is pure helium.

4. The method of claim 1, wherein the first process gas includes less than about 20% oxygen by weight.

5. The method of claim 2, wherein the first process gas includes less than about 1% oxygen by weight.

6. The method of claim 5, wherein the first process gas is free of oxygen.

7. The method of claim 1, wherein the step of heating further includes:
replacing the first process gas with a second process gas which is at least primarily argon to drive off helium from the molten silica.

8. The method of claim 7, wherein the second process gas is introduced after substantially all the silica particles which are to be melted in the heating step have been melted.

9. The method of claim 7, wherein the second process gas is pure argon.

10. The method of claim 1, wherein the step of feeding silica includes:
mixing the silica with a feed gas; and
introducing the feed gas to the chamber, the feed gas including helium.

11. The method of claim 10, wherein the feed gas includes less than 20% oxygen by weight.

12. The method of claim 11, wherein the feed gas includes about 1% oxygen by weight to remove volatile organic contaminants from the silica during the step of heating.

13. The method of claim 10, wherein the feed gas includes at least 0% helium.

14 The method of claim 1, wherein the step of heating includes:
establishing a gas plasma arc between spaced electrodes within the chamber to heat the chamber.

15. The method of claim 14, wherein the step of heating includes:
flowing the first process gas into the chamber through a passage defined by a first of the electrodes.

16. The method of claim 1, wherein the step of heating includes flowing the first process gas through the chamber at a rate of 200 cubic ft/hr.

17. A method for producing a silica glass body having a low bubble content comprising the steps of:
melting silica in a chamber of a furnace by establishing a gas plasma arc between spaced electrodes within the chamber;
during the step of melting, feeding a process gas into the chamber, the process gas including at least about 70% by weight of helium.

18. The method of claim 17, wherein the process gas includes at least 95% by weight of helium.

19. The method of claim 17, wherein the pressure within the chamber is from about 0.1 to about 3 atmospheres.

20. The method of claim 17 further including, after the step of melting:
feeding a second process gas into the chamber, the second process gas including argon.

21. An apparatus for producing a silica glass body having a low bubble concentration comprising:
a housing which defines an interior chamber;
means for feeding silica particles into the chamber;
first and second spaced electrodes extending into the chamber;
a source of power connected with the electrodes for generating an arc between the electrodes for heating the chamber;
a source of a first process gas which includes helium;
a source of a second process gas which includes argon; and
a manifold which selectively fluidly connects the first and second sources of process gas with the chamber.
